(19) United States
(12) Patent Application Publication
(10) Pub. No.: US 2013/0046650 A1
(43) Pub. Date: Feb. 21, 2013

(54) Method and System for Online Auctions

(71) Applicants: Jeff Geurts, Edmond, OK (US); Ashley Smith, Edmond, OK (US); Marc A. Brockhaus, Oklahoma City, OK (US); Angel Gerdzhikov, Moore, OK (US)

(72) Inventors: Jeff Geurts, Edmond, OK (US); Ashley Smith, Edmond, OK (US); Marc A. Brockhaus, Oklahoma City, OK (US); Angel Gerdzhikov, Moore, OK (US)

(21) Appl. No.: 13/589,655

(22) Filed: Aug. 20, 2012

Related U.S. Application Data
(60) Provisional application No. 61/525,082, filed on Aug. 18, 2011.

(51) Int. Cl. G06Q 30/08

(52) U.S. Cl. 705/26.3

(57) ABSTRACT

An online auction system includes a host system which has at least one processor executing processor executable code, at least one non-transient memory communicating with the at least one processor and storing processor executable code, wherein the processor executable code when executed by the at least one processor, causes the at least one processor to: (1) transmit a first signal to a network indicative of a first auction presentation page for auctioning an item, the first auction presentation page having a bid mechanism and being free of a buy-now mechanism; (2) receive a first bid signal from a user terminal indicative of a first activation of the bid mechanism; and (3) in response to receiving the first bid signal transmit a second signal to the user terminal over the network indicative of at least a portion of the first auction presentation page having a buy-now mechanism.

### CROSS-REFERENCE TO RELATED APPLICATIONS

This application claims priority to U.S. Provisional Application Ser. No. 61/525,082 filed on Aug. 18, 2011, the entire contents of which are hereby expressly incorporated herein by reference.

### COPYRIGHT NOTICE

A portion of the disclosure of this patent document contains material which is subject to copyright protection under U.S. law and other laws. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The inventive concepts disclosed herein generally relate to online auctions, and more particularly, but not by way of limitation, to a system and method for online auctions.

Online auctions have existed in various forms since as early as the late 1970's, long before the advent of the World Wide Web, when primitive auctions were conducted on early Internet Bulletin Board Services. Modern online auctions began in 1995 with the launch of AuctionWeb, which would later become eBay®.

The penny auction industry was born in September 2005, when Telebid launched in Germany. Penny auctions are distinct from traditional online auctions in that bidders pay a participation fee for each bid placed. Telebid users were initially required to phone-in bids, but the site was later modified to allow users to place bids through a web browser. In 2008, Telebid changed its name to Swoopo and expanded to several other countries, including the U.S. and U.K. Many other penny auctions were soon launched in the U.S. and elsewhere, including QuiBids, BigDeal, BidCactus, BidRivals, and Beezid.

### SUMMARY

The inventive concepts disclosed herein relate to online auction systems and methods configured to allow users to bid for items offered for sale in an online auction.

In one aspect, the inventive concepts disclosed herein are directed to an online auction system comprising a host system comprising at least one processor executing processor executable code, at least one non-transient memory communicating with the at least one processor and storing processor executable code. The processor executable code when executed by the at least one processor, causes the at least one processor to: (1) transmit a first signal to a network indicative of a first auction presentation page for auctioning an item, the first auction presentation page having a bid mechanism and being free of a buy-now mechanism; (2) receive a first bid signal from a user terminal indicative of a first activation of the bid mechanism; and (3) in response to receiving the first bid signal transmit a second signal to the user terminal over the network indicative of at least a portion of the first auction presentation page having a buy-now mechanism.

In another aspect, the inventive concepts disclosed herein are directed to an online auction system comprising a host system including at least one processor executing processor executable code, at least one non-transient memory communicating with the at least one processor and storing processor executable code. The processor executable code, when executed by the at least one processor, causes the at least one processor to: (1) transmit a first signal to a network indicative of a first auction presentation page for auctioning an item, the first auction presentation page having a bid mechanism, a buy now mechanism, a list price of the item, and a first auction price; (2) receive a first bid signal indicative of an activation of the bid mechanism from a first user terminal associated with a first user having a billing account; and (3) in response to receiving the first bid signal, place an electronic hold for a first amount on the billing account of the first user and transmit a second signal to the network indicative of at least a portion of the first auction presentation page having a second auction price.

In yet another aspect, the inventive concepts disclosed herein are directed to an online auction system comprising: a host system comprising at least one processor executing processor executable code; at least one non-transient memory communicating with the at least one processor and storing processor executable code. The processor executable code when executed by the at least one processor, causes the at least one processor to: (1) transmit a first signal to a network indicative of a first auction presentation page for auctioning an item, the first auction presentation page having a bid mechanism, a list price of the item, and a buy-now mechanism; (2) receive a first bid signal indicative of a first activation of the bid mechanism from a first user terminal associated with a first user having a first user account including one or more bids; (3) deduct a bid from the first user account; (4) receive a buy-now signal indicative of an activation of the buy-now mechanism from the first user terminal; (5) in response to receiving the buy-now signal, charge the first user account for the list price of the item; and (6) credit at least one bid back into the first user account.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a schematic diagram of an exemplary embodiment of an online auction system according to the instant disclosure.

FIG. 2 is a block diagram of an exemplary embodiment of a memory according to the instant disclosure.

FIG. 3 is an exemplary embodiment of a method of registering users according to the instant disclosure.

FIG. 4A is an exemplary embodiment of an auction presentation page according to the instant disclosure.

FIG. 4B is another exemplary embodiment of an auction presentation page with a bid mechanism according to the instant disclosure.

FIG. 4C is yet another exemplary embodiment of an auction presentation page with a bid mechanism and a buy-now mechanism according to the instant disclosure.

FIG. 5 is an exemplary embodiment of an auction logic according to the instant inventive concept.

FIG. 6 is an exemplary embodiment of an auction logic according to the instant inventive concept.

FIG. 7 is an exemplary embodiment of an auction logic according to the instant inventive concept.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

The inventive concepts disclosed herein are generally directed to a method and system for online auctions, and more particularly, but not by way of limitation to a method and system for online auctions such as penny auctions. The online auctions will be described hereinafter in the context of penny auctions, but it is to be understood that the instant inventive concepts are equally applicable to other types of auctions, as will be understood by a person of ordinary skill in the art presented with the instant disclosure.

As used herein, the terms “network-based,” “cloud-based,” and any variations thereof, are intended to cover the provision of configurable computational resources on demand via interfacing with a computer network, with software and/or data at least partially located on the computer network, by pooling the processing power of two or more networked processors.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used in the instant disclosure the terms “provide,” “providing,” and variations thereof comprise displaying or providing for display an auction page to one or more user terminals interfacing with a computer network and/or allowing the one or more user terminals to participate in an auction, such as by interacting with one or more mechanisms on an auction page in order to view the auctioned item and/or place a bid on the item, and/or purchase the auctioned item, regardless of whether the user has placed a bid on the item (e.g., “buy-now” mechanism), by sending and/or receiving digital or optical signals via a computer network interface (e.g. an Ethernet port, a TC/IP port, an optical port, a cable modem, and combinations thereof), for example. A user may be provided with the auction presentation page in a web browser, or in a software application, for example.

As used herein the term “bid mechanism,” and any variations thereof comprises a feature of the graphical user interface or a feature of a software application, allowing a user to indicate to a host system that the user wishes to place a bid in an auction, such as by interfacing with the host system over a computer network and exchanging digital or optical signals with the host system using a network protocol, for example. Such bid mechanism may be implemented with computer executable code executed by at least one processor, for example, with a button, a hyperlink, an icon, a clickable symbol, and combinations thereof, that can be activated by a user terminal interfacing with the at least one processor over a computer network, for example.

As used herein the term “bid signal” refers to a signal that indicates that a user wishes to place a bid in an online auction. A bid signal can be generated and transmitted to a host system over a network by a user terminal responsive to a selection of the bid mechanism.

As used herein the term “buy-now mechanism” and any variations thereof comprises a feature of the graphical user interface or a feature of a software application, allowing a user to indicate to a host system that the user wishes to buy an item in an auction, such as by interfacing with the host system over a computer network and exchanging digital or optical signals with the host system using a network protocol, for example. Such buy-now mechanism may be implemented, for example, as a button, a hyperlink, an icon, a clickable symbol, and combinations thereof, that can be activated by a user terminal interfacing with the at least one processor over a computer network, for example. Such buy-now mechanism may be available to users regardless of any bids placed by the users, for example, or may be available to users on fulfillment of a predetermined condition, such as submitting a predetermined number of bids.

As user herein the terms “item,” “items,” and variations thereof are not limited to tangible items, and may include services, bids, bid packs, coupons, subscriptions, virtual items, virtual currencies, and combinations thereof, for example.

It is to be further understood that as used herein the term “user” and variations thereof is not limited to a human being, and may comprise a computer, a server, a website, a processor, a network interface, a human, a user terminal, a virtual computer, a tablet, a smart phone, a host system, and combinations thereof, for example.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

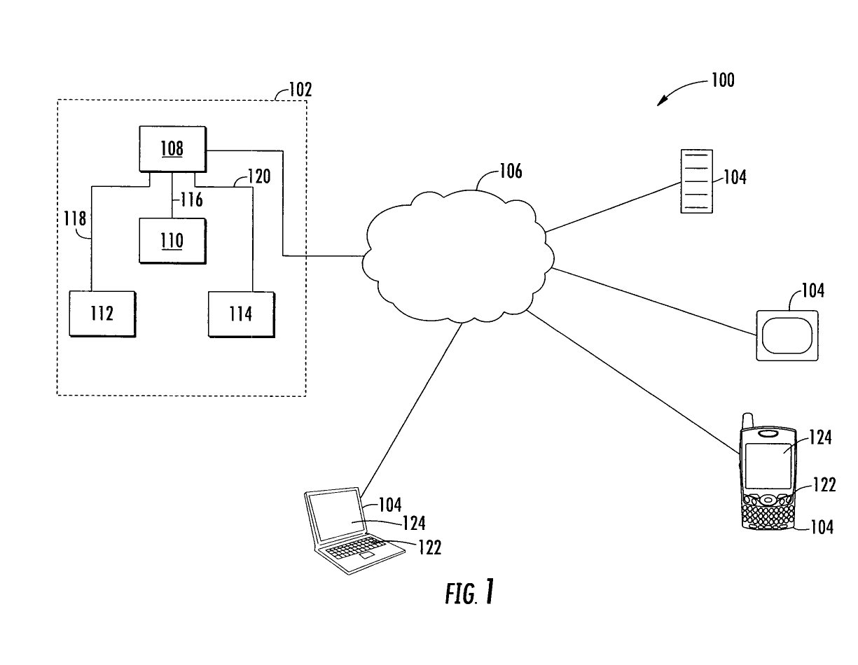

Referring now to FIG. 1, shown therein is an exemplary embodiment of an online auction system 100 according to the instant disclosure. The online auction system 100 comprises one or more host systems 102 capable of interfacing and/or communicating with one or more user terminals 104 via a network 106.

The one or more host systems 102 comprise one or more processors 108 capable of executing processor executable code, one or more memory 110 capable of storing processor executable code, an input device 112, and an output device 114, which can be partially or completely network-based or cloud-based, and not necessarily located in a single physical location.

The one or more processors 108 can be implemented as a single or multiple processors 108 working together to execute the logic described herein. Exemplary embodiments of the one or more processor 108 include a digital signal processor (DSP), a central processing unit (CPU), a field programmable gate array (FPGA), a microprocessor, a multi-core processor, and combinations thereof. The one or more processor 108 is capable of communicating with the one or more memories 110 via a path 116 which can be implemented as a data bus, for example. The one or more processor 108 is capable of communicating with the input device 112 and the output device 114 via paths 118 and 120, respectively. Paths 118 and 120 may be implemented similarly to, or differently from, path 116. The one or more processor 108 is further capable of interfacing and/or communicating with the one or more user terminals 104 via the network 106, such as by exchanging electronic, digital and/or optical signals via one or more physical or virtual ports using a network protocol such as TCP/IP, for example. It is to be understood that in certain embodiments using more than one processor 108, the one or more processor(s) 108 may be located remotely from one another, located in the same location, or comprising a unitary multi-core processor (not shown). The one or more processor 108 is capable of reading and/or executing processor executable code and/or of creating, manipulating, altering, and storing computer data structures into one or more memory 110.

The one or more memory 110 stores processor executable code and may be implemented as any conventional non-transient memory 110, such as random access memory (RAM), a CD-ROM, a hard drive, a solid state drive, a flash drive, a memory card, a DVD-ROM, a floppy disk, an optical drive, and combinations thereof, for example. It is to be understood that while one or more memory 110 is shown located in the same physical location as the host system 102, the one or more memory 110 may be located remotely from the host system 102 and may communicate with the one or more processor 108 via the network 106. Additionally, when more than one memory 110 is used, one or more memory 110a may be located in the same physical location as the host system 102, and one or more memory 110b may be located in a remote physical location from the host system 102. The physical location(s) of the one or more memory 110 can be varied, and the one or more memory 110 may be implemented as a “cloud memory” i.e., one or more memory 110 which is partially, or completely based on, or accessed using the network 106.

The input device 112 transmits data to the processor 108, and can be implemented as a keyboard, a mouse, a touchscreen, a camera, a cellular phone, a tablet, a smart phone, a PDA, a microphone, a network adapter, and combinations thereof, for example. The input device 112 may be located in the same physical location as the host system 102, or may be remotely located and/or partially or completely network-based. The input device 112 communicates with the processor 108 via path 118.

The output device 114 transmits information from the processor 108 to a user, such that the information can be perceived by the user. For example, the output device 114 can be implemented as a server, a computer monitor, a cell phone, a tablet, a speaker, a website, a PDA, a fax, a printer, a projector, a laptop monitor, and combinations thereof. The output device 114 can be physically co-located with the host system 102, or can be located remotely from the host system 102, and may be partially or completely network based (e.g., a website). The output device 114 communicates with the processor 108 via the path 120.

The network 106 preferably permits bi-directional communication of information and/or data between the host system 102 and the user terminals 104. The network 106 may interface with the host system 102 and the user terminals 104 in a variety of ways, such as by optical and/or electronic interfaces, and may use a plurality of network topographies and protocols, such as Ethernet, TC/IP, circuit switched paths, and combinations thereof, for example. For example, the network 106 can be implemented as the World Wide Web (or Internet), a local area network (LAN), a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and combinations thereof, and may use a variety of network protocols to permit bi-directional interface and communication of data and/or information between the host system 102 and the one or more user terminals 104.

The one or more user terminals 104 can be implemented as a personal computer, a smart phone, network-capable TV set, TV set-top box, a tablet, an e-book reader, a laptop computer, a desktop computer, a network-capable handheld device, a video game console, a server, a digital video recorder, a DVD-player, a Blu-Ray player, and combinations thereof, for example. In an exemplary embodiment, the user terminal 104 comprises an input device 122, an output device 124, a processor (not shown) capable of interfacing with the network 106 and executing processor executable code (not shown), and a web browser capable of accessing a website and/or communicating information and/or data over a network, such as the network 106. As will be understood by persons of ordinary skill in the art, the one or more user terminals 104 may comprise one or more non-transient memories comprising processor executable code and/or software applications, for example.

The input device 122 is capable of receiving information input from a user and/or another processor, and transmitting such information to the user terminal 104 and/or to the host system 102. The input device 122 may be implemented as a keyboard, a touchscreen, a mouse, a trackball, a microphone, a fingerprint reader, an infrared port, a slide-out keyboard, a flip-out keyboard, a cell phone, a PDA, a video game controller, a remote control, a fax machine, a network interface, and combinations thereof, for example.

The output device 124 outputs information in a form perceivable by a user and/or another processor. For example, the output device 124 can be a server, a computer monitor, a screen, a touchscreen, a speaker, a website, a TV set, a smart phone, a PDA, a cell phone, a fax machine, a printer, a laptop computer, and combinations thereof. It is to be understood that in some exemplary embodiments, the input device 122 and the output device 124 may be implemented as a single device, such as for example a touchscreen or a tablet.

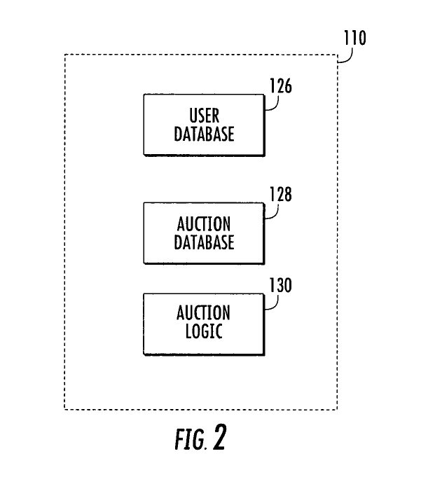

Referring now to FIG. 2, the one or more memory 110 preferably stores processor executable code and/or information comprising a user database 126, an auction database 128, and an auction logic 130. The processor executable code may be written in any suitable programming language, such as C++, for example. The user database 126 and the auction database 128 can be stored as a data structure, such as a relational database and/or one or more data table(s), for example.

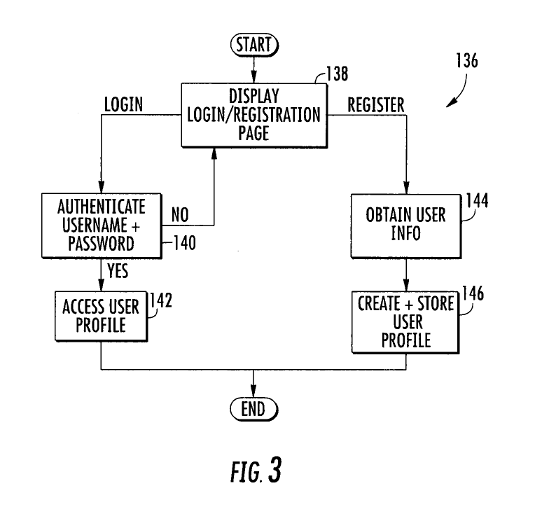

The user database 126 preferably comprises information about the registered users with the host system 102. In an exemplary embodiment shown in FIG. 3, one or more users accessing an auction website of the host system 102 via the user terminal 104 can be directed by the processor 108 to a login/registration portion of the website in a step 138. If the user has previously registered with the host system 102, the user may be prompted by the processor 108 to provide login credentials (such as a username and password), which allow the processor 108 to authenticate the user against the user database 126 in a step 140. Each user of the host system 102 preferably has a user profile including information stored in the user database 126. The host system 102 accesses the user profile in a step 142. The user profile may include the following information: demographic information including name, age, address, billing account information, username, password, behavioral information, experience, gender, and the like, for example. If the user authentication is successful, the user's profile is accessed by the processor 108. If the user authentication fails, the user may be returned to the login/registration page, where the user may be prompted for a username and password again. Optionally, the processor 108 may block a user from entering a username and password after a preset number of failed authentication attempts. It is to be understood that the user database 126 may further comprise user profiles for users who have not registered with the host system 102, but who have previously visited or are currently accessing an auction website maintained by the host system 102, for example.

If the user is not registered with the host system 102, demographic information, billing account information, shipping address, desired username, and password, and other information may be collected from the user and/or generated by the host system 102 in a step 144. Further in step 144, the user may be allowed to purchase one or more bids and/or bid packs and such purchased bids and/or bid packs may be credited to the user's account. It is to be understood that bids for which the user pays monetary consideration may be hereinafter referred to as “real bids.” Other types of bids may not cost the user any money and may be referred to as “free bids,” “bid-bank bids,” and “bonus bids,” for example. Such free bids, bid-bank bids, and/or bonus bids may be used or placed in one or more auctions 134a-n, but may not result in a reduction of the list price of the item, as will be understood by persons of ordinary skill in the art presented with the instant disclosure, for example.

A user profile is created and preferably stored in the user database 126 by the processor 108 in a step 146. The user profile may be stored in the user database 126 and may be provided, or made available to a user in the form of a user account/registration page, as will be understood by persons of ordinary skill in the art presented with the instant disclosure, for example.

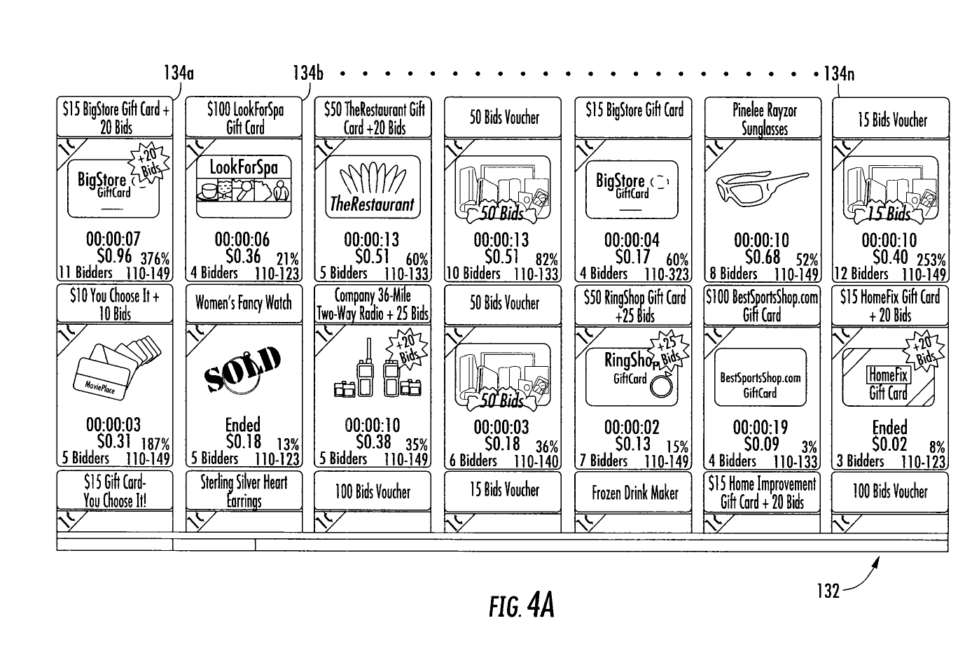

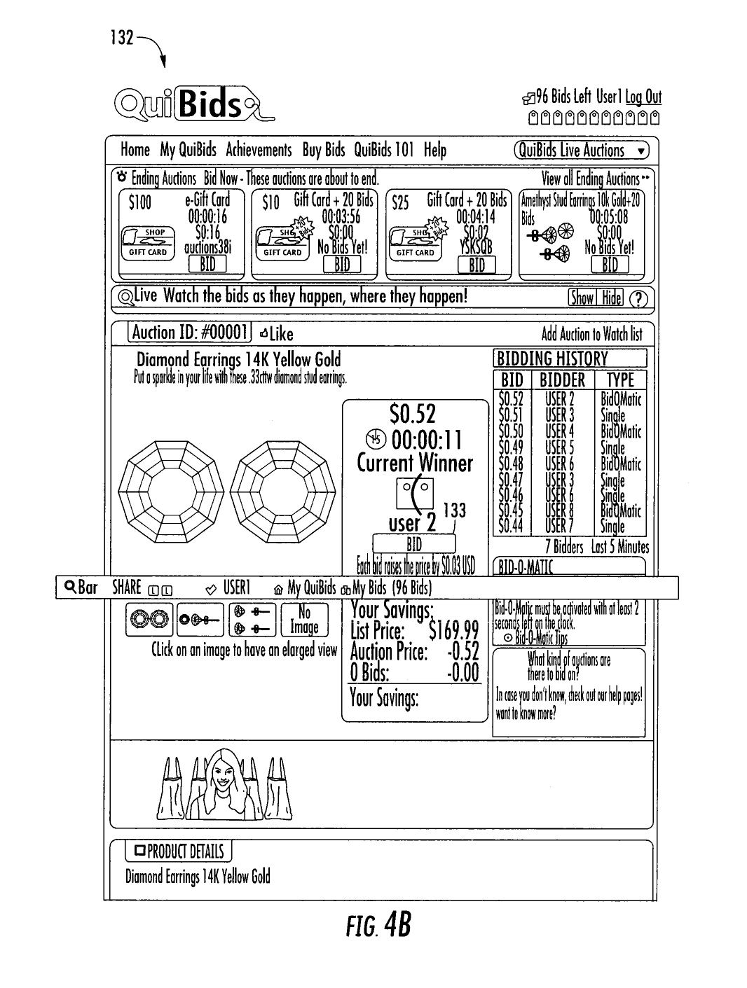

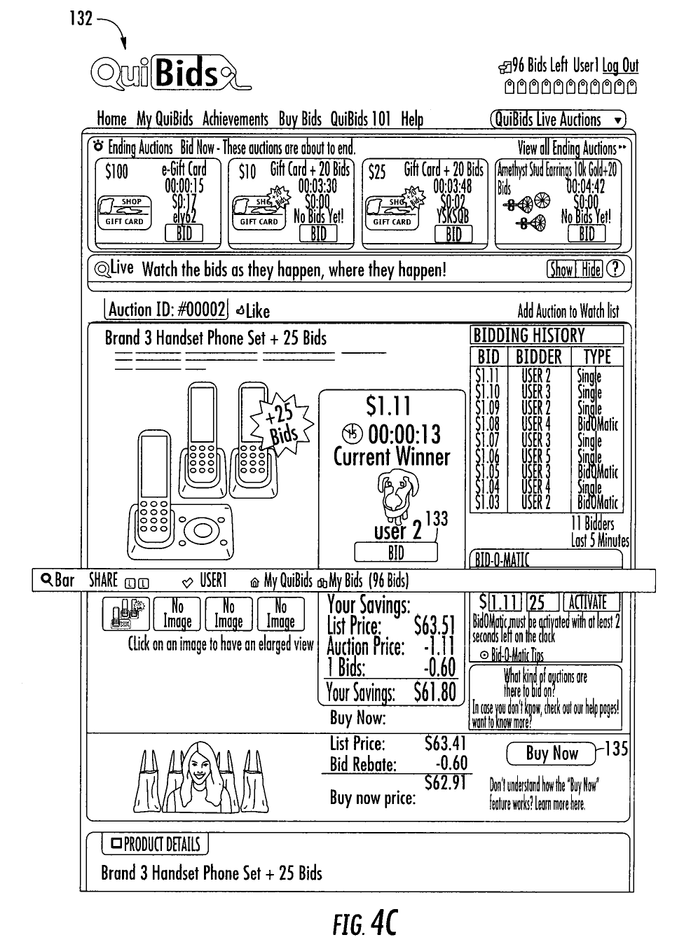

Referring now to FIGS. 4A-4C, an exemplary embodiment of the auction database 128 preferably comprises one or more auctions 134a-n, one or more of which may be provided to a user via the transmission of signals over the network 106. The signals are preferably computer executable code that can be rendered into one or more auction presentation pages 132, for example by software/hardware of the user terminals 104. For example, the signals can be in the form of hypertext mark-up language (HTML) that can be used to create documents on the World Wide Web. HTML defines the structure and layout of a web document by using a variety of tags and attributes. The user terminals 104 may include a software program referred to as a web browser for reading the HTML documents and composing such HTML documents into visible or audible web pages. The auction presentation page 132 displays multiple simultaneous auctions.

Shown in FIGS. 4B and 4C are other examples of the auction presentation page 132. The auctions 134a-n preferably comprise start time, end time, auctioned item, list price, auction price, cost to bid, and time remaining until the auction 134a-n ends. The auction presentation pages 132 may comprise one or more mechanisms such as a bid mechanism 133 (FIG. 4B) allowing a user to place a bid on the item, and a buy-now mechanism 135 (FIG. 4C) allowing the user to buy the item. The auctions 134a-n may be scheduled to begin at a certain time (start time), run (or be open) for a certain amount of time, and end at a certain time (end time), for example. An auction timer displayed on the auction presentation pages 132 may be started by the processor 108 at the start time of an auction 134a and may countdown time to the end time of the auction 134a, for example. Such auction timer may be reset one or more times during the auction 134a, and the end time may be dynamically pushed back in response to bids received in the auction 134a as will be described below, for example. As can be seen in FIG. 4A, in some exemplary embodiments, when an auction 134a-n ends, the item may be listed as “sold,” and an auction end price may be displayed on the auction presentation page 132.

The memory 110 further stores processor executable code and/or instructions, which may comprise auction logic 130 (FIG. 2). The auction logic 130 comprises processor executable instructions and/or code, which when executed by the processor 108, cause the processor 108 to generate, maintain, provide, and/or host a website providing one or more online auctions 134a-n, for example. The auction logic 130 further causes the processor 108 to provide the one or more online auctions 134a-n to one or more users and to allow the one or more users to participate in the one or more online auctions 134a-n as will be described herein below, for example. Providing an online auction 134a-n may comprise scheduling an auction 134a-n, storing the scheduled auction into auction database 128, and providing the auction 134a-n by displaying the auction presentation page 132, starting the auction timer at the scheduled time, and allowing one or more users to bid in the auction 134a-n and/or purchase the auctioned item, for example.

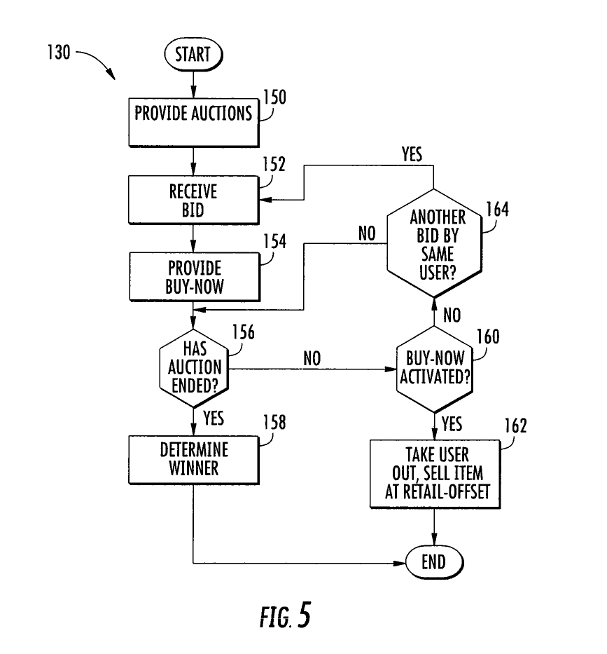

Referring now to FIG. 5, shown therein is an exemplary embodiment of an auction logic 130 which may be used with an online auction system 100 according to the instant disclosure. The auction logic 130 comprises processor executable code, which when executed by the processor 108 may cause the processor 108 to execute one or more of a plurality of steps as follows:

The auction logic 130 branches to a step 150 where a user terminal 104 interfacing with the processor 108 over a network 106 is provided with one or more auctions 134a-n having the bid mechanism 133 allowing a user to place a bid. The auctions 134a-n preferably have a list price, an auction price, a start time, and an end time, for example. The list price may be any price at which an owner/operator of the host system 102 is willing to sell an item, such as a retail price, an on-sale price, a wholesale price, and combinations thereof, for example. The list price can be displayed on the auction presentation page 132 in an amount of currency, such as United States dollars, or as a number of bids with each bid having a bid value, such as $0.60. The auction price may be the price at which the auctions 134a-n start, and such auction price may be raised as described herein, for example. The auction price can also be displayed on the auction presentation page 132 in an amount of currency. The one or more auctions 134a-n provided to a user may be currently ongoing auctions 134a-n (i.e., the timer is started and has not reached the end time or zero), auctions 134a-n which may have already ended (i.e., the timer has reached the end time of the auction 134a-n, or zero if the end time has been extended one or more times), or auctions 134a-n which may be scheduled to begin at some time after a user is provided with the auctions 134a-n, and combinations thereof, for example. In some embodiments, a user has purchased one or more bids or bid packages (or packs) comprising a plurality of bids in advance of bidding in the auctions 134a-n, and such bids or bid packs have been credited to the user's account and/or stored into the user database 126. It is to be understood that one or more auctions 134a-n may be provided to a user who is logged in the host system 102 and/or to a user not logged in and/or registered with the host system 102. However, a user may be required to log in and/or register with the host system 102 prior to participating in one or more auctions 134a-n, for example.

The auction logic 130 branches to a step 152 where one or more bids is/are received from a user in one or more auctions 134a-n over the network 106. In response to receiving at least one bid from a user in an auction 134a, the auction logic 130 deducts the bid from the user's account, raises the auction price by a preset amount (e.g., one penny for each bid placed, or the value of each real bid placed), and optionally resets the auction timer by a predetermined amount of time (e.g., 10 seconds, 15 seconds, 20 seconds), preferably in real time, for example. For example, if less time remains in the auction than the pre-determined amount of time by which the auction timer is reset, the auction end time is dynamically pushed forward in time. Of course, if more time remains in the auction 134a than the predetermined amount of time by which the auction timer will be reset, the timer may not be reset (e.g., retaining the originally scheduled auction end time), or the auction end time may be accelerated to end after the predetermined amount of time by which the auction timer is reset (e.g., an auction that was originally scheduled to end in 60 seconds, is reset to end in 20 seconds in response to receiving a bid), for example.

The auction logic 130 branches to a step 154 which comprises, in response to receiving at least one bid from a user terminal 104 interfaced with the host system 102 over the network 106, providing the user with the buy-now mechanism 135 to buy the item now at a buy-now price, which may be a list price of the item, or a discounted list price of the item. Discounted or reduced list prices, as discussed herein are preferably only displayed on the auction presentation page 132 for the particular user who submitted bid(s). Further, preferably only the user terminal 104 being used by the user is provided with a signal to render the discounted or reduced list price onto the auction presentation page 132. The buy-now mechanism 135 may not be available to a user that has not placed at least one bid in the auction 134a, and may only be provided to the user in response to the host system 102 receiving an initial (or at least one) bid from the user in the auction 134a, for example. In other words, the auction logic 130 may prevent a user from purchasing the item at the list price. Such initial bid is preferably a real bid, i.e., a bid purchased by the user by itself or as a part of a bid pack, and for which bid the user paid money, but it may be a free bid or a bonus bid, for example.

In some exemplary embodiments, the auction logic 130 may provide the user with a buy-now price which reflects the list price of the item, or a discount off the list price of the item for the value of the at least one bid received from the user in step 154 described above. In another exemplary embodiment, rather than discounting the list price of the item by the value of the at least one bid received in step 154, the auction logic 130 may discount the list price of the item by an arbitrary discount amount, not corresponding to the value of the at least one bid received, such as $1, $10, and $0.10, for example, in order to provide the buy-now price to the user. Further, such arbitrary discount amount may be provided to the user even if the at least one bid received is not a real bid—e.g., an arbitrary discount amount may be provided in response to the processor 108 receiving at least one bonus bid and/or at least one free bid in the auction 134a. The arbitrary discount amount may be chosen by a random or pseudo-random process and may be provided with upper and lower boundaries, such as $0.01-$1.00, for example.

The auction logic 130 branches to a step 156 where the host system 102 determines if the auction 134a has ended such as by determining if the auction timer has reached the end time of the auction 134a, or if the end time has been extended, determining if the auction timer has counted down to zero, for example.

If the auction 134a has ended, the auction logic 130 continues to a step 158 where it is determined if the user is a winning user or a non-winning user. A winning user of the auction 134a can be determined, if the user is the last user from whose user terminal 104 a bid was received in the auction 134a. A non-winning user is a user which is not a winning user as described above, for example.

If the auction 134a has not ended, the auction logic 130 branches to a step 160 where it is determined if the buy-now mechanism 135 has been activated by the user. If the buy-now mechanism 135 has been activated, the auction logic 130 moves to a step 162 where the item is sold to the user at the list price of the item discounted as described above in response to the user activating the buy-now mechanism 135, for example. If the buy-now mechanism 135 has not been activated, the auction logic 130 moves to a step 164 where it is determined if another bid has been received by the user in the auction 134a. If another bid has been received from the user, the auction logic 130 cycles back to step 152. If another bid has not been received from the user, the auction logic 130 cycles back to step 156.

It is to be understood that if the one or more of the bids received from the user in the auction 134a are bonus bids and/or free bids, the list price may not be discounted for such bids, or may be discounted by a zero amount, or by some other arbitrary, random, or pseudo-random amount, for example.

Once the auction logic 130 has ended, a conventional purchase confirmation page and/or other information such as tracking or shipping information may be provided to the user by the host system 102, for example. The user's billing account may be electronically charged for any applicable shipping and/or handling costs. As will be understood by persons of ordinary skill in the art, the user may be provided with a receipt and/or other transaction and/or shipping confirmation information, for example.

Optionally, the buy-now mechanism 135 may be provided to users for as long as the auction 134a has not ended, and in some exemplary embodiments such buy-now mechanism 135 may be provided for some limited time after the auction 134a has ended (e.g., one hour, two hours, twenty-four hours, 2 days, 45 minutes, as a one-time option prior to closing the auction, etc.). Such availability of the buy-now mechanism 135 after the auction 134a has ended may only be provided in response to receiving more than a predetermined minimum number of bids in the auction 134a from a user, for example.

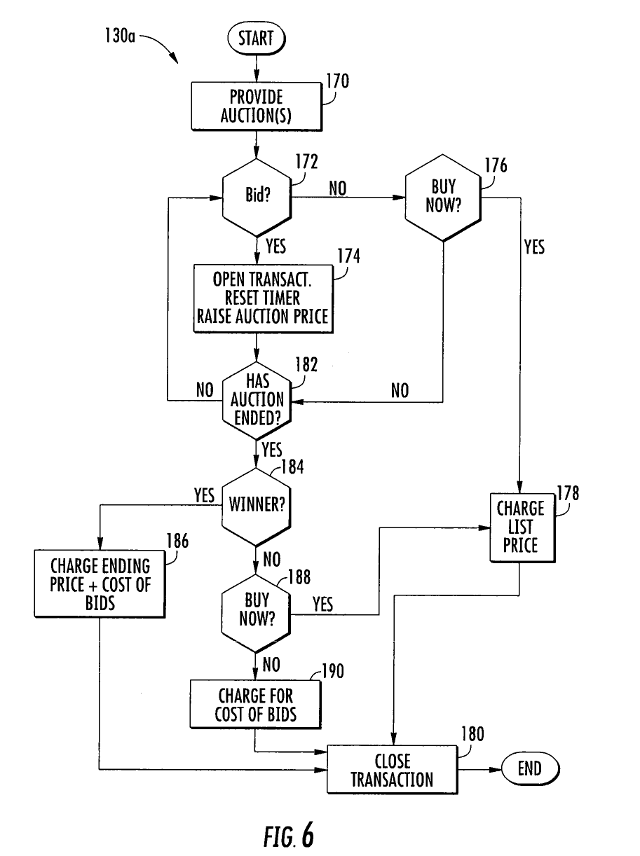

In another exemplary embodiment of auction logic 130a shown in FIG. 6, a user is not required to purchase any bids and/or bid packs prior to participating in the one or more auctions 134a-n. Accordingly, in this exemplary embodiment, no bids are provided to the user at any time and no bids are deducted from, or credited to, the user's account, as will be described below. In this exemplary embodiment, the auction logic 130a when executed by processor 108 causes the processor 108 to execute one or more of a plurality of steps as follows:

The auction logic 130a branches to a step 170 to provide one or more auctions 134a-n with auction presentation pages 132 having the bid mechanism 133 allowing a user to place a bid on an auctioned item, and the buy-now mechanism 135 allowing a user to buy the item now at the item's list price. The one or more auctions 134a-n are provided to user terminals 104 interfacing with the network 106, and may have a start time, an auction item, a list price, an auction price, a cost to place a bid, and an end time, for example. The one or more auctions 134a-n provided to users may be ongoing (i.e., the timer is started), may have already ended (i.e., the timer has reached the end time of the auction 134a-n), or may be scheduled to begin at some time after the users are provided with the auctions 134a-n, and combinations thereof, for example. It is to be understood that such auctions 134a-n may be provided to users who are logged in the host system 102, or to users who are not logged in the host system 102, but which users are accessing a web site generated by the host system 102.

The auction logic 130a branches to a step 172 to determine if a bid has been placed by a user terminal 104 in the auction 134a, such as by determining if information was received via the network interface, e.g., a bid signal, indicating that the bid mechanism 133 has been activated by the user, for example. If a bid has been placed by the user, the auction logic 130a proceeds to step 174 where an electronic billing transaction is opened on the user's billing account, the auction price is raised by a predetermined increment amount, and optionally the end time is reset by a predetermined amount of time (e.g., 10 seconds, 15 seconds), in response to the user placing a bid on the auction 134a. The electronic billing transaction may comprise a charge transaction, such as electronically pre-authorizing and/or placing an electronic hold on a certain amount of funds on the user's credit card account, for example. Such amount of electronically held funds is preferably less than or at most equal to the list price of the item auctioned in the auction 134a the user has bid on, for example. Alternatively, such electronically held amount of funds may be less than the list price of the item the user has bid on, ranging from a nominal amount (e.g., $0.01 for low value items) to a pre-set amount of less than the list price of the item (e.g., $10 for an item that is listed for more than $10), for example. Determining the amount of electronically held funds may comprise accessing the user database 126 and/or other data stored in the memory 110 to obtain a user's demographic information (including, but not limited to age, gender, and address), the user's experience (including but not limited to: past wins, past bids, number of bids placed, number of auctions won, number of uses of buy-now mechanism, number of wins within a preset period of time, total value of items won) and/or other user-specific behavioral information/factors, for example.

It is to be understood, however, that in some exemplary embodiments of auction logic 130a according to the instant disclosure, the auction logic 130a may omit placing electronic authorization holds on users' billing accounts, and may simply electronically charge users' billing accounts as described herein without electronically holding any funds in advance of placing the charge on the account. Such exemplary embodiments may be implemented for low list price items (e.g., less than $50), and/or for “verified” users (e.g., users who have been registered for a certain amount of time, and/or who have bought and paid for a certain number or value of items), and combinations thereof, for example.

If no bid has been placed by the user, the auction logic 130a proceeds to a step 176 which comprises determining whether the buy-now mechanism 135 has been activated by the user. In response to the buy-now mechanism 135 being activated by the user, the auction logic 130a branches to a step 178, where the user is removed from the auction 134a and electronically charged for the list price of the item. As used herein “removed from the auction 134a” comprises redirecting the user's browser to a purchase confirmation page, and if the user was the last user to bid in the auction 134a, removing the user as the last user to place a bid and listing the next-to-last user that placed a bid as the new last user to place a bid, for example. The user that has been removed from the auction 134a may optionally be allowed to re-enter the auction 134a once the user completes the electronic purchase transaction (e.g., the auction logic 130a completes step 180 as described below, and the auction 134a is still ongoing), and the auction logic 130a may start from step 170 and treat the user as if they are entering the auction 134a for the first time, for example. As will be understood by persons of ordinary skill in the art, allowing a user to re-enter the auction 134a may desirably be done for fungible or non-unique items, and/or for items of which more than one is available to be sold to users.

The auction logic 130a ends with a step 180 to close the billing transaction, such as by electronically charging the user's account for the list price for the item and for any other applicable charges (e.g. shipping and handling), and electronically releasing any funds held in excess of the total charges.

In response to the user placing a bid in step 172, and if a billing transaction has been opened in step 174, the auction logic 130a determines if the auction 134a has ended in a step 182. If the auction 134a has not ended, the auction logic 130a cycles back to step 172.

If the auction 134a has ended, the auction logic 130a determines if the user is a winning user or a non-winning user of the auctions 134a in a step 184. The winning user may be the last user to place a bid prior to the end of the auction 134a, or the user who placed the most bids in the auction 134a, for example. A non-winning user is a user that is not a winning user as described above, for example.

If the user is the winning user of the auction 134a, the user's billing account is electronically charged the ending auction price and for the cost of the bids placed in the auction 134a in a step 186. The auction logic 130a proceeds to step 180 as described above.

If the user is a non-winning user, the auction logic 130a may offer the non-winning user the option to activate the buy-now mechanism 135 and determine if the non-winning user had activated the buy-now mechanism 135 in a step 188. In response to the non-winning user activating the buy-now mechanism 135, the auction logic 130a cycles to step 178 as described above. In response to the non-winning user not activating the buy-now mechanism 135, the auction logic 130a branches to a step 190 to electronically charge the billing account of the non-winning user for the cost of the bids placed in the auction 134a, and proceeds to the step 180 as described above.

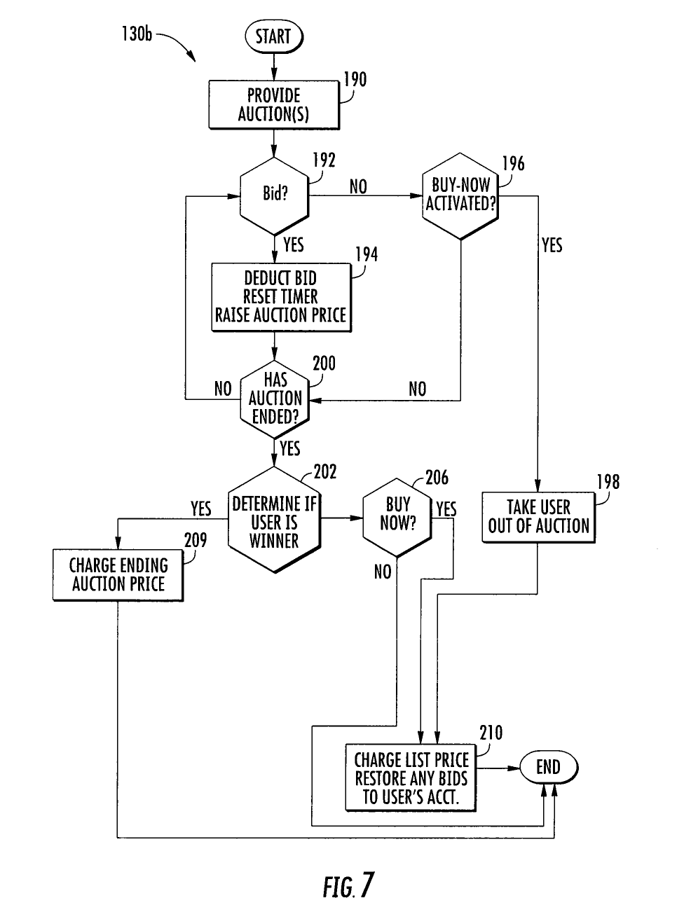

In an exemplary embodiment of an auction logic 130b shown in FIG. 7, the auction logic 130b comprises processor executable code which when executed by the processor 108, causes the processor 108 to execute one or more of a plurality of steps, as follows:

The auction logic 130b branches to a step 191 to provide one or more users with one or more auctions 134a-n having the bid mechanism 133 allowing a user to bid on an auctioned item, and the buy-now mechanism 135 allowing a user to buy the item now at the item's list price. The one or more auctions 134a-n may be provided to the one or more user terminals 104 interfacing with the host system 102 over the network 106, and may have a start time, an auction item, a list price, an auction price, and an end time, for example. The one or more auctions 134a-n provided to users may be ongoing (i.e., the timer is started), may have already ended (i.e., the timer has reached the end time of the auction 134a-n), or may be scheduled to begin at some time after the users are provided with the auctions 134a-n, and combinations thereof, for example. It is to be understood that such auctions 134a-n may be provided to one or more users which are logged in the host system 102, and/or to one or more users which are not logged in the host system 102, but which users are accessing a web site provided by the host system 102.

The auction logic 130b branches to a step 192 to determine if a bid has been received from a user in an auction 134a, such as by the user activating the bid mechanism 133, for example. In response to receiving a bid from the user, the auction logic 130b proceeds to step 194 where the bid is electronically deducted from the user's account, the auction price is raised by a predetermined increment amount, and optionally the end time is reset by a predetermined amount of time (e.g., 10 seconds, 15 seconds), in response to receiving a bid from the user in the auction 134a, preferably in real-time, for example.

If no bid has been received from the user, the auction logic 130b proceeds to a step 196 to determine whether the buy-now mechanism 135 has been activated by the user.

In response to the buy-now mechanism 135 being activated by the user, the auction logic 130b branches to a step 198, where the user is removed from the auction 134a. The auction logic 130b continues to a step 210 to electronically charge the user's billing account for the list price for the item and for any other applicable charges (e.g. shipping and handling), and to automatically restore any bids deducted from the user's account back into the user's account. It is to be understood that in some embodiments only real bids may be restored into the user's account, and free bids and bonus bids may not be restored into the user's account, for example. It should further be understood that the list price can be reduced by bids placed in other auctions 134a-n by the user and for items other than the item(s) being paid for in the step 210, for example.

If a bid has been received from the user in step 192, and the bid has been electronically deducted from the user's account in step 194, the auction logic 130b determines if the auction 134a has ended in a step 200. If the auction 134a has not ended, the auction logic 130b cycles back to step 192.

If the auction 134a has ended, the logic 130b determines if the user is a winning user or a non-winning of the auction 134a that ended in a step 202. A winning user may be the last user from whose user terminal 104 a bid was received over the network 106 prior to the end of the auction 134a, or the user from whom the most bids were received, for example. A non-winning user is a user who is not a winning user as described above, for example.

If the user is the winning user, the user is electronically charged the ending auction price at a step 204. Alternatively step 204 may comprise electronically charging the winning user for the list price of the item and automatically restoring any bids placed back into the winning user's account, and/or electronically providing the winning user's account with extra bids, such as real bids, free bids, and bonus bids, for example.

If the user is a non-winning user, the auction logic 130b may provide the non-winning user with the opportunity to activate the buy-now mechanism 135 and determine if the non-winning user has activated the buy-now mechanism 135 at a step 206. In response to the non-winning user activating the buy-now mechanism 135, the auction logic 130b cycles to step 210 as described above. In response to the non-winning user not activating the buy-now mechanism 135, the auction logic 130b optionally electronically restores any deducted bids back into the non-winning user's account and ends, for example.

As will be understood by persons of ordinary skill in the art, the cost for placing a bid in an auction 134a-n may vary with the number of bids received and/or the time remaining before the auction 134a-n ends, and may be manually set by an administrator of the host system 102, for example.

In some embodiment, the auction logic 130b may comprise an optional step (not shown) comprising providing a “walk-away” mechanism, allowing the user to leave the auction 134a prior to its end by causing the auction logic 130b to move to step 206 prior to the auction ending, for example. Optionally, should the user decide to return to the auction 134a which they have walked away from prior to its end, the auction logic 130b may automatically restore previously deducted bids into the user's account and proceed from step 190 as described above.

It is to be understood that optionally free bids and/or bonus bids may likewise be electronically provided to the user's account as part of restoring the bids placed as described above, in certain bonus auction, for example.

As an optional feature, the auction logic 130b may limit the total number of bids that may be received from a user on an item to the list price of the item divided by the cost of each bid (rounded to a whole number as needed). At the point where the maximum allowed number of bids for an item have been received from a user terminal 104 over the network 106, the item may be automatically awarded and/or sold to the user at the list price, the bids may be electronically restored to the user's account, and the user's billing account may be electronically charged for the list price, preferably in a single charge transaction, for example. This feature may be particularly advantageous for novice users who are thereby protected from spending more than the list price for an item, and automatically win the item once they have placed enough bids to incur a charge equal to the list price. As will be understood by persons of ordinary skill in the art, items auctioned in such “protected” auctions 134a-n are preferably not unique, and a plurality of such items is available to be auctioned.

In some exemplary embodiments, a similar value and/or type item may be offered to a user in order to avoid shipping delays and/or rain checks if the number of items automatically won by users as described above exceed the number of items currently available for shipping.

In an exemplary embodiment of an auction logic 130, 130a, and/or 130b according to the instant disclosure, a user has several available options.

One of the options allows the user to buy an item at the list price. The user finds an auction having an item they wish to buy at its list price, the user simply indicates this by pressing, clicking on, or otherwise activating a “buy-now,” “purchase item at list price,” or other similar mechanism, such as a button or hyperlink on an auction webpage, for example. In this option, the user may not have yet placed any bids on the selected item to be auctioned. In this case, the host system 102 electronically charges the user's billing account for the list price of the item, for example. The host system 102 may optionally provide the user with a purchase confirmation number, a purchase confirmation e-mail, or another confirmation document, such as a confirmation screen, order number, electronic receipt, and combinations thereof, for example. The host system 102 may also initiate the shipping of the item to a user-selected address, such as by contacting a warehouse or a shipping company, for example.

Another option allows the user to bid in an auction in order to win the auction. The user finds an auction 134a-n having an item they wish to bid on. The host system 102 receives one or more bids on the item from a user, such as by the user activating the bid mechanism 133. The host system 102 raises the auction price of the item and/or extends the auction end time in response to bids submitted by the user and/or other users. The host system 102 preferably electronically deducts each placed bid from the user's account. In some exemplary embodiments, the host system 102 may provide the buy-now mechanism 135 in response to a user submitting a bid, comprising a discounted list price, and such discounted list price may reflect an arbitrary discount given for each bid placed. The arbitrary discount may not correspond to the actual bid value in any way, e.g., the same arbitrary discount may be given for a real bid, a free bid, and a bonus bid. Further, the arbitrary discount may vary with the number of users participating in the auctions 134a-n, the number of bids placed by the particular user, the remaining number of bids in the user's account, the bidding history of the user, the experience of the user, and other user' specific or non-user specific information available to the host system 102 and/or stored in the user database 126.

Another option allows the user to participate in an auction 134a-n and leave the auction 134a-n at will. This option is similar to option two, except that after placing one or more bids in an auction 134a, the user decides they no longer wish to participate in the auction 134a. The user is then presented with two options: “walk away” or “buy item at list price.” The user may indicate a choice to walk away empty-handed (e.g., by pressing a button or clicking on a hyperlink), at which time the host system 102 may charge the user's billing account for the cost of the bid(s) placed by the user in the auction 134a or the host system 102 may deduct such bids from the user's account. The user may or may not have the option to change their mind at a later time and re-enter the auction 134a-n they previously walked away from or another auction 134a-n, and such later time may be limited to the end time of the auction 134a, or may extend some period of time after the end of the auction 134a, depending on item uniqueness and availability, for example.

Alternatively, the user may indicate they wish to no longer bid by electing to purchase the item at list price. At such time, the host system 102 may electronically charge the user's billing account for the list price of the item. This option may only be available to users who are not the last user that has bid on the item, for example. Further the option to re-enter the auction 134a may not be available where the auctioned item is unique (e.g., artwork, collectible items, personalized items, rare items, etc.).

Another exemplary embodiment of auction logic according to the instant inventive concept(s) is similar to auction logic 130b, except that in response to the user being a winning user in an auction 134a, or in response to a user activating the buy-now mechanism 135, the user is electronically charged for the list price of the item, regardless of any bids received from the user. Then, in a separate transaction, carried out at a later time (e.g., 2 hours later, 24 hours later, after the auction ends, etc.) the account of the winning user or the user who activated the buy-now mechanism 135 may be electronically credited for the cost of any bids received from the user in the auction 134a.

In an exemplary embodiment of auction logic 130, 130a, and/or 130b according to the instant disclosure, the buy-now mechanism 135 is not provided to a user at the outset of an auction 134a-n. Instead, the user is required to place a predetermined number (e.g., 1, 2, 3 . . . ) of bid(s) in an auction 134a-n. In response to receiving a first bid, for example, from the user in an auction 134a-n, the auction logic provides the user with the buy-now mechanism 135.

In another exemplary embodiment of auction logic 130, 130a, and/or 130b according to the instant disclosure, two or more bids are received from a user in an auction 134a. The auction logic provides for display a reduced list price, which is calculated by subtracting the value of one, more than one, or all bids places from the list price of the item. In an exemplary embodiment, not every bid received from the user is used to reduce the list price. For example, every other bid may be used, every third bid, only odd bids, only even bids, not credit the first bid, not credit the third bid, stop crediting after a certain number of bids, etc. In addition a random or pseudo-random process may be used to determine whether credit is given for a particular bid received from the user. In some exemplary embodiments, the user may be asked to play a game of chance or skill to determine which bids are credited to determine the reduced list price.

In another exemplary embodiment of auction logic 130, 130a, and/or 130b according to the instant disclosure, a user may be electronically charged the full list price of an item upon winning a first auction 134a and/or activating the buy-now mechanism in the first auction 134a. Bids received from the user during the first auction 134a, may not be used to reduce the list price of the item in the first auction 134a, and may be used to reduce the list price of an item in a second action 134b in which the user has bid and/or activated the buy-now mechanism 135. The second auction 134b does not have to occur at a later time than the first auction 134a, but may also run concurrently with the first auction 134a, for example. Further, such credited bids may be stored in an electronic “bid bank”—e.g. data, or an address to stored data, that can be a designated portion of the user's account with the host system 102, and such credited bids in the bid bank may only be usable in certain auctions 134a-n and may expire if unused within a certain amount of time after they have been earned, for example. Such bid-bank bids may be provided only to users who have bid in an auction 134a-n, but did not win the item and did not activate the buy-now mechanism 135, for example. In other exemplary embodiments, however, such bid-bank bids may be provided for each bid placed by a user, only for real bids placed by a user, and are not limited to a 1:1 ratio, for example. In this way, a real bid placed by a user may result in 2 or more bid-bank bids credited to the user's bid bank, and a free-bid or a bonus bid may result in 1 or less bid-bank bids credited to the user's bid bank, for example.

In some exemplary embodiments, auction logic 130, 130a, and/or 130b according to the instant disclosure may set the list price of the item to be a much higher price than the value or list price of the item (a price that the seller does not expect to get for the item), for example. Such much higher list price may be reduced in response to the bids received from a user in the auction 134a-n, the time elapsed in the auction 134a-n, the number of users who have viewed the auction 134a-n but have not placed a bid yet, and other similar factors, for example.

In exemplary embodiments, auction logic 130, 130a, and/or 130b according to the instant disclosure may provide only partial discount of or credit against the list price for the bids received from a user. For example, the list price may be reduced by an amount that does not correspond to the bid value. In an exemplary embodiment, the list price may be reduced by a formula, which varies the percentage of the bid value that is credited against the list price over time and/or over the number of bids placed. As will be understood by a person of ordinary skill in the art, the first bid received from the user may result in a nominal credit (e.g., 1% of the bid value), and subsequent bids may result in incrementally, linearly, of geometrically increasing increments of credits, such as 10%-20%-30% . . . -99%, for example, in order to encourage users to place more bids in an auction. Of course, in other embodiments the progression may be inversely related to the number of bids received from the user, such as 99% for the first bid, and a declining % for each bid received thereafter, for example. In some embodiments, the % credit may be constant, or vary with time, e.g., a lower percent credits for bids received at the last few seconds before the auction 134a-n ends, and a higher percent credit for bids received a certain amount of time prior to the auction 134a-n end.

In an exemplary embodiment of auction logic 130, 130a, and/or 130b according to the instant inventive concept, the percent credit for each bid received may increase as the number of users bidding in a particular auction 134a-n increases, for example. In other exemplary embodiments, the percent credit for bids may be larger for higher-list price items, and smaller for low-list price items, for example.

In addition, in an exemplary embodiment of the instant inventive concept, some users may be assigned special status by the system 100, such as an administrator, a super-user, a manager, and combinations thereof, for example. In the case of administrator-status users, options such as changing passwords and/or usernames of users, disabling user accounts, and other administrative options may be available to the user and may be shown in the user account/registration page.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the scope and spirit of the inventive concepts disclosed herein and defined by the appended claims.

What is claimed is:

1. An online auction system comprising:
a host system comprising at least one processor executing processor executable code, at least one non-transient memory communicating with the at least one processor and storing processor executable code, wherein the processor executable code when executed by the at least one processor, causes the at least one processor to:
transmit a first signal to a network indicative of a first auction presentation page for auctioning an item, the first auction presentation page having a bid mechanism and being free of a buy-now mechanism;
receive a first bid signal from a user terminal indicative of a first activation of the bid mechanism; and
in response to receiving the first bid signal transmit a second signal to the user terminal over the network indicative of at least a portion of the first auction presentation page having a buy-now mechanism.

2. The online auction system of claim 1, further comprising data indicative of a list price of the item stored in the non-transient memory, and wherein the processor executable code when executed by the at least one processor, causes the at least one processor to (1) receive a second bid signal from the user terminal over the network, indicative of a second activation of the bid mechanism, and (2) calculate a reduced list price of the item based on (a) the list price of the item, and (b) only one of the first bid signal and the second bid signal.

3. The online auction system of claim 2, wherein the second bid signal has a predetermined value, and wherein calculating the reduced list price of the item is further defined as deducting at least a portion of the predetermined value of the second bid signal from the list price of the item.

4. The online auction system of claim 2, wherein calculating the reduced list price of the item further includes deducting an arbitrary value from the list price of the item responsive to receiving the first bid signal or the second bid signal.

5. The online auction system of claim 1, wherein the first bid signal corresponds to a first bid, and wherein the processor executable code when executed by the at least one processor, causes the at least one processor to electronically charge a billing account of the user a predetermined amount for the first bid in response to receiving the first bid signal.

6. The online auction system of claim 5, wherein the first auction presentation page includes a list price of the item, and wherein the processor executable code when executed by the at least one processor, causes the at least one processor to electronically charge the billing account of the user for the list price of the item in response to receiving a buy now signal indicative of the activation of the buy now mechanism from the user terminal.

7. The online auction system of claim 6, wherein the processor executable code when executed by the at least one processor, further causes the at least one processor to electronically credit the billing account of the user for the predetermined amount for the first bid.

8. The online auction system of claim 1, wherein the user terminal is associated with a first user, and wherein the processor executable code when executed by the at least one processor, causes the at least one processor to remove the first user from the auction in response to a number of first bid signals received from the user terminal exceeding a predetermined number.

9. The online auction system of claim 8, wherein the item has an item list price, the first bid signal is associated with a bid value, and wherein the predetermined number is based on a summation of the bid values of first bid signals received from the user terminal exceeding the list price of the item.

10. The online auction system of claim 1, wherein the first bid signal is associated with a first bid having a bid value, and wherein the first auction presentation page is configured to display a list price of the item in number of first bids.

11. The online auction system of claim 1, wherein the buy-now mechanism includes at least one of a button and a hypertext link.

12. An online auction system comprising:
a host system comprising at least one processor executing processor executable code, at least one non-transient memory communicating with the at least one processor and storing processor executable code, wherein the processor executable code when executed by the at least one processor, causes the at least one processor to:
transmit a first signal to a network indicative of a first auction presentation page for auctioning an item, the first auction presentation page having a bid mechanism, a buy now mechanism, a list price of the item, and a first auction price;
receive a first bid signal indicative of an activation of the bid mechanism from a first user terminal associated with a first user having a billing account; and
in response to receiving the first bid signal, place an electronic hold for a first amount on the billing account of the first user and transmit a second signal to the network indicative of at least a portion of the first auction presentation page having a second auction price.

13. The online auction system of claim 12, wherein the processor executable code when executed by the at least one processor, causes the at least one processor to:
receive a buy now signal indicative of an activation of the buy now mechanism from the first user terminal; and
in response to receiving the buy now signal remove the first user from the auction and charge the billing account of the first user for the list price of the item.

14. The online auction system of claim 12, wherein the first auction presentation page includes an auction end time and the first bid signal is indicative of a first bid having a value, and wherein the processor executable code when executed by the at least one processor, further causes the at least one processor to:
charge the billing account of the first user for the value of the first bid in response to the auction end time being reached.

15. The online auction system of claim 12, wherein the buy-now mechanism comprises at least one of a button and a hypertext link.

16. An online auction system comprising:
a host system comprising at least one processor executing processor executable code; at least one non-transient memory communicating with the at least one processor and storing processor executable code, wherein the processor executable code when executed by the at least one processor, causes the at least one processor to:
transmit a first signal to a network indicative of a first auction presentation page for auctioning an item, the first auction presentation page having a bid mechanism, a list price of the item, and a buy-now mechanism;
receive a first bid signal indicative of a first activation of the bid mechanism from a first user terminal associated with a first user having a first user account including one or more bids;
deduct a bid from the first user account;
receive a buy-now signal indicative of an activation of the buy-now mechanism from the first user terminal;
in response to receiving the buy-now signal, charge the first user account for the list price of the item; and
credit at least one bid back into the first user account.

17. The online auction system of claim 16, wherein the buy-now mechanism comprises at least one of a button and a hypertext link.
